(19) United States
(12) Patent Application Publication
(10) Pub. No.: US 2006/0047041 A1
(43) Pub. Date: Mar. 2, 2006

(54) Composition of master batch and outsole made from the same

(76) Inventors: Hee-Dae Park, Busan (KR); Metha Yagnick, Rahway, NJ (US)

Correspondence Address: ST. ONGE STEWARD JOHNSTON & REENS, LLC, 986 BEDFORD STREET, STAMFORD, CT, 06905-5619, US

(21) Appl. No.: 10/930,083

(22) Filed: Aug. 31, 2004

(51) Int. Cl. C08K 5/09

(52) U.S. Cl. 524/394

(57) ABSTRACT

Disclosed is a composition of a master batch for manufacturing an outsole, without plating an outsole forming mold with any material and applying an external mold release agent onto the mold to easily release a formed outsole from the mold. The composition consists of a binder of ethylene-propylene dine monomer, an internal mold lubricant, acidic additives, and sulfur or titanium.

### FIELD OF THE INVENTION

The present invention relates to a master batch for an outsole of shoes, and more particularly, to a composition of a master batch capable of manufacturing an outsole, without plating an outsole forming mold with any material and applying an external mold release agent onto the mold to easily release a formed outsole from the mold.

### BACKGROUND OF THE RELATED ART

Generally, an outsole of shoes is made by compression molding a substrate through a press molding method, the substrate comprising ethylenevinyl acetate (EVA) copolymer, 1,2-polybutadiene, natural rubber, styrene butadiene rubber (SBR), and butadiene rubber, or a polymer of the components. The press molding method is well known in the art, and thus the detained description thereof will be omitted herein. For reference, the method is disclosed in Korean Unexamined Patent Publication Nos. 2000-1970 entitled “method and apparatus for manufacturing sole of shoes” and 2000-9283 entitled “method for manufacturing outsole of shoes”.

When the outsole is manufactured through the press molding method, a water-based or solvent-based external mold release agent is applied onto a mold, before a material for forming the outsole is inputted into the mold and is then compression formed. This is because the formed outsole is easily released from the mold.

Specifically, after the water-based mold release agent or solvent-based mold release agent is applied onto a steel or aluminum mold, a process of releasing the mold is repeatedly performed in 10 to 20 cycles for a white master batch, or in 20 to 30 cycles for a carbon master batch, to manufacture the outsole.

However, if the outsole is manufactured by use of the mold release agent, the steel or aluminum mold is contaminated or corroded by the mold release agent. Also, since a rubber is built up in the mold, the mold should be frequently cleaned. In addition, if the mold release agent is not uniformly applied onto the mold, the outsole may not be properly adhered to the shoes. Furthermore, it is required for additional apparatus and process of applying the mold release agent onto the mold.

Meanwhile, the steel or aluminum mold should be plated with chrome or Teflon, prior to the production of the outsole. Such a plating process may cause some problems.

Specifically, environmental pollution is resulted from the plating process. In particular, in the case where the mold is plated with chrome, pollutants, such as a chrome compound, heavy metals, corrosive substances, toxic substances, and acid/alkali wastewater, are produced.

A plating solution of Teflon contains a harmful solvent, such as N-methylpyrrolidene (NMP) or dimethylformamide (DMF), as a diluent. After volatile solvent and plating solution are applied to the mold, toxic substances of Teflon are dissolved when the mold is heated by high temperature. Workers are directly exposed to the toxic gas, which has a detrimental effect upon a human body.

In addition, if fluorinated polymer, which is a major component of a coating, is heated, trifluoroacetic acid (TFA), ozone-destroying chlorofluorocarbon (CFC), long-chain perfluorocarboxylate or the like are produced from the fluorinated polymer. CFC is a chief culprit in thinning the ozone. TFA having toxicity is accumulated in animals and human bodies. Also, the plating solution of chrome is a heavy metal in itself, and is restricted by WHO, in which Chromium(Vi) is designated as a carcinogenic substance.

Although an external mold release agent (EMR) is used to open the mold after the steel mold or aluminum mold is plated with Teflon, it is often difficult to open the mold by force. After that, the mold should be again plated with Teflon. This process is a major factor of a defective coating in the plating process. In addition, an excessive use of flattering agent for lowering the gloss of the mold may cause another defective coating. In the case where the coating is failed, a mold release agent (MRA) is excessively used.

For normal plating, it is possible to release the mold even by spraying MRA once per 4 hours. A period of plating the mold is different from a few weeks to two months per factory. The mold should be sandblasting whenever the plating is performed. The mold is worn away by 0.01 mm a once of the sandblasting.

### SUMMARY OF THE INVENTION

Accordingly, the present invention is directed to a master batch for an outsole that substantially obviates one or more problems due to limitations and disadvantages of the related art.

An object of the present invention is to provide a composition of a master batch capable of manufacturing an outsole, without plating an outsole forming mold with any material and applying an external mold release agent onto the mold to easily release a formed outsole from the mold.

Another object of the present invention is to provide an outsole made from the composition of master batch.

Still another object of the present invention is to provide a composition of a sulfur master batch used in production of an outsole.

Further another object of the present invention is to provide a composition of a TiO₂ master batch used in production of an outsole.

Further still another object of the present invention is to provide a TiO₂ master batch or a sulfur master batch capable of lowering adhesion defective and increasing adhering power of an outsole.

To achieve the object and other advantages, according to one aspect of the present invention, there is provided a composition of a master batch for producing an outsole, without plating an outsole forming mold with any material and applying an external mold release agent onto the mold to easily release a formed outsole from the mold, the composition consisting of: a binder of ethylene-propylene dine monomer; an internal mold lubricant; acidic additives; and sulfur or titanium.

Preferably, the composition of the internal mold lubricant is referred to the composition disclosed in Korean Patent No. 381653 issued on Apr. 11, 2004, of which is incorporated by reference therein.

Specifically, the internal mold lubricant comprises branched hydrocarbon having a molecular weight of 400 to 2800; phospholipids containing lecithin, which is stable for a heat; carboxylic acid; and metal salt of carboxylic acid. Alternatively, the internal mold lubricant comprises branched hydrocarbon having a molecular weight of 800 to 2000; long-chain carboxylic acid having a molecular weight of 200 to 800; metal complex of long-chain carboxylic acid having a molecular weight of 200 to 800; and ionized monomer.

Also, the present invention provides a sulfur master batch or a TiO₂ master batch claimed in claims 4 to 7.

It is to be understood that both the foregoing general description and the following detailed description of the present invention are exemplary and explanatory and are intended to provide further explanation of the invention as claimed.

### DETAILED DESCRIPTION OF PREFERRED EMBODIMENTS

A preferred embodiment according to the present invention will now be explained. The below described embodiments of the present invention are intended to be illustrative only. Those skilled in the art may devise numerous alternative embodiments without departing from the scope of the following claims.

The present invention teaches a master batch of TiO₂ (NC MB-TiO₂ 75(A), NC MB-TiO₂ 80; brand name) and a sulfur master batch (NC MB-Is75, NC MB-S 80; brand name), by which a formed outsole can be released from a mold, without using an external mold release agent and plating the mold with toxic substance, when the outsole is produced. In particular, the master batches of the brand names are suitable for the steel mold, and can increase a content of insoluble sulfur used as a binder.

The TiO₂ master batch of the present invention has physical properties that a size of TiO₂ particles is small, and TiO₂ particles have a strong permeability to a metal and absorb the moisture very well. Consequently, the TiO₂ master batch easily contaminates the non-plating mold, which exerts influence on the release of the formed outsole from the mold. In order to prevent the above problem, the TiO₂ master batch is produced by encapsulation technique for coating each composition, which will be described hereinafter.

The TiO₂ master batch may be of any forms such as rutile type and anatase type, and may be applied to a light color.

Compositions of sulfur master batch and TiO₂ master batch and a composition ratio thereof for embodying the above characteristics and effects are described in detail in Tables 1 and 2. The best effects may be obtained by the composition ratio described in the below Tables 1 and 2. Thoughts of the present invention relate to a composition of a master batch used to manufacture an outsole, i.e., a composition of a master batch capable of releasing the formed outsole from the mold, without plating the outsole forming mold with any material and applying the external mold release agent onto the mold.

TABLE 1
Sulfur Master Batch

| Composition | | | |
|---|---|---|---|
| | Brand | | Composition |
| No. | Name | Chemical | ratio (wt. %) |
| 1 | ERP | atactic polypropylene | 10˜14 |
| 2 | #2504 | KEP/VISTALON ethylene | 1˜3 |
| | | propylene rubber | |
| 3 | RROSGEN | Polyethylene wax, | 0.05˜0.5 |
| | #212 | paraffin sax, G.M.S | |
| 4 | HJ-310 | Hydro treated lube | 1˜8 |
| | | base oil, antioxidant, | (Common |
| | | ultraviolet blocking agent | sulfur) |
| 5 | TL 700L2 | phosphoric acid mono | 1˜3 |
| | | and dialkyl, fatty acid, | |
| | | unsaturated mixture of | |
| | | alkenes and vegetable | |
| | | oil, sulfured, trioctyl | |
| | | phosphate, paraffin oil | |
| 6 | Armoslip | Octadecenamide, stearic | 0.1˜1.0 |
| | HT | amide, steyl amide, | |
| | | stearic acid amide | |
| 7 | Lactic | Lactic acid, water | 0.05˜0.5 |
| | Acid | | (Insoluble |
| | | | sulfur) |
| 8 | Sulfur | Sulfur | 35˜90 |
| 9 | Crystex | Polymeric sulfur, naphthenic | 35˜90 |
| | OT20 | oil, sulfur | (Insoluble |
| | | | sulfur) |

TABLE 2
TiO₂ Master Batch

| Composition | | | |
|---|---|---|---|
| | Brand | | Composition |
| No. | Name | Chemical | ratio (wt. %) |
| 1 | ERP | atactic polypropylene | 2˜15 |
| 2 | EPDM | KEP/VISTALON ethylene | 1˜5 |
| | #2504 | propylene | |
| 3 | EVA#150 | Ethylene-vinyl acetate | |
| | | copolymer, Vinyl acetate, | |
| | | process aids | |
| 4 | RROSGEN | Polyethylene wax, | 0.05˜0.5 |
| | #212 | paraffin wax, G.M.S | |
| 5 | Tixosil | Precipitated amorphous | 0.5˜1.5 |
| | T-38 | silica | |
| 6 | TL A-3 | Composition of oleo- | 0.1˜1.5 |
| | | chemical derivatives | |
| 7 | TL 700L2 | Fatty acid ester, fatty | 0.5˜5 |
| | | amide, partially | |
| | | saponified butyl esters | |
| 8 | Armoslip | Octadecenamide, stearic | |
| | HT | amide, steyl amide, | |
| | | stearic acid amide | |
| 9 | KA-100 | Anatase titanium di-oxide | 70˜80 |
| | | | (Anatase type) |
| 10 | R-103 | Titanium dioxide, | 75˜85 |
| | | aluminum hydroxide, | (Rutile type) |
| | | amorphous silica (7631-86-9): | |
| | | 0˜10% | |

Preferred embodiments of the present invention will now be described in detail, but the present invention is not restricted thereto. It will be noted that the compositions described in each embodiments are not represented by a chemical name, but represented by a brand name shown in Tables 1 and 2.

### Embodiment 1

Insoluble sulfur master batch (NC MB-IS 75; brand name) was produced by mixing EPR of 12.5 wt. %, #2504 of 1.3 wt. %, RROSGEN#212 of 0.2 wt. %, TL 700L2 of 2.5 wt. %, Armoslip HT of 0.3 wt. %, lactic acid of 0.2 wt. %, sulfur of 42 wt. %, and Crystex OT20 of 41 wt. %.

### Embodiment 2

A common sulfur master batch (NC MB-S 80; brand name) was produced by mixing EPR of 11.0 wt. %, #2504 of 2.4 wt. %, RROSGEN#212 of 0.2 wt. %, HJ-31 0 of 3.4 wt. %, TL 700L2 of 1.6 wt. %, Armoslip HT of 0.6 wt. %, and sulfur of 80.8 wt. %.

### Embodiment 3

A TiO₂ master batch of anatase type (NC MB-TiO₂ 75(A); brand name) was produced by mixing EPR of 12.3 wt. %, EPDM#2504 of 3.5 wt. %, EVA#150 of 2.0 wt. %, RROSGEN#212 of 0.2 wt. %, Tixosil T-38 of 1.0 wt. %, TL A-3 of 1.0 wt. %, TL 700L2-TC of 3.0 wt. % Armoslip HT of 2.0 wt. %, and KA-100 of 75 wt. %.

### Embodiment 4

A TiO₂ master batch of rutile type (NC MB-TiO₂ 80; brand name) was produced by mixing EPR of 12.8 wt. %, EPDM#2504 of 2.2 wt. %, EVA#150 of 1.0 wt. %, RROSGEN#212 of 0.2 wt. %, Tixosil T-38 of 1.0 wt. %, TL A-3 of 0.3 wt. %, TL 700L2-TC of 1.0 wt. %, Armoslip HT of 1.5 wt. %, and KA-100 80 of wt. %.

If the brand names, “NC MB-IS 75”, “NC MB-S 80”, “NC MB-TiO2 75(A)”, “NC MB-TiO2 80”, are used for the manufacture of the outsole, it is not necessary to plate the mold with toxic substance such as Teflon or chrome, and to apply the mold with external mold release agent.

Also, there is no difference between the insoluble sulfur master batch (NC MB-IS 75) and the common sulfur master batch (NC MB-S 80). However, the insoluble sulfur master batch is used for an expensive outsole, while the common sulfur master batch is used for a cheap outsole.

The TiO₂ master batch is used to make the white outsole. Specifically, when manufacturing the outsole, the sulfur master batch is added, and then the TiO₂ master batch is added to manufacture the white outsole. The TiO₂ master batch is classified into the anatase type and a rutile type. The TiO₂ master batch of rutile type (NC MB-TiO₂ 80) is used to embody lighter color relative to the anatase type.

With the above description, the present invention has some advantages as follows.

First, Teflon or chrome is not applied on a surface of the mold for manufacturing the outsole, thereby reducing a manufacturing cost and preventing the environmental pollution.

Second, the steel mold or aluminum mold is not again plated in the course of continuously manufacturing the outsole, thereby improving the productivity and minimizing the number of molds to be carried.

Third, the mold is not plated and uses the external mold release agent in used, thereby preventing the corrosion of the mold and thus extending the period of cleaning work.

Fourth, the present invention does not utilize the external mold release agent, thereby manufacturing an outsole of high quality and reducing an adhesive defective of the outsole.

And finally, the present invention provides the mixture with good mixing ability, thereby reducing wear-out of machinery, improving the durability thereof, and increasing consistent dispersion and adhesion to improve a physical property of the outsole.

The foregoing embodiments are merely exemplary and are not to be construed as limiting the present invention. The present teachings can be readily applied to other types of apparatus. The description of the present invention is intended to be illustrative, and not to limit the scope of the claims. Many alternatives, modifications, and variations will be apparent to those skilled in the art.

What is claimed is:

1. A composition of a master batch for manufacturing an outsole, without plating a mold for forming shoes with any material and applying an external mold release agent onto the mold to easily release a formed outsole from the mold, the composition consisting of:
a binder of ethylene-propylene dines monomer;
an internal mold lubricant;
acidic additives; and
sulfur or titanium.

2. The composition as claimed in claim 1, wherein the internal mold lubricant comprises:
Branched hydrocarbon having a molecular weight of 400 to 2800;
Phospholipids containing lecithin, which is stable for a heat;
carboxylic acid; and
metal salt of carboxylic acid.

3. The composition as claimed in claim 1, wherein the internal mold lubricant comprises:
branched hydrocarbon having a molecular weight of 800 to 2000;
long-chain carboxylic acid having a molecular weight of 200 to 800;
metal complex of long-chain carboxylic acid having a molecular weight of 200 to 800; and
ionized monomer.

4. An outsole for shoes made of the composition as claimed in claim 1.

5. A composition of a master batch for manufacturing an outsole of shoes, the composition consisting of:
atactic polypropylene;
KEP/VISTALON ethylene propylene rubber;
a compound of polyethylene wax, paraffin wax, and G.M.S;
a compound of phosphoric acid mono and dialkyl, fatty acid, unsaturated mixture of alkenes and vegetable oil, sulfurised, trioctyl phosphate, and paraffin oil;
a compound of octadecenamide, stearic amide, steyl amide, stearic acid amide;
lactic acid;
sulfur; and
polymeric sulfur, naphthenic oil, and sulfur.

6. An outsole for shoes made of the composition as claimed in claim 5.

7. A composition of a master batch for manufacturing an outsole of shoes, the composition consisting of:
atactic polypropylene;
KEP/VISTALON ethylene propylene rubber;
a compound of polyethylene wax, paraffin wax, and G.M.S;
a compound of hydrotreated lube base oil, antioxidant, and ultraviolet blocking agent;
a compound of phosphoric acid mono and dialkyl, fatty acid, unsatd mixed with alkenes and vegetable oil, sulfurised, trioctyl phosphate, paraffin oil;
a compound of octadecenamide, stearic amide, steyl amide, and stearic acid amide; and
sulfur.

8. An outsole for shoes made of the composition as claimed in claim 7.

9. A composition of a master batch for manufacturing an outsole of shoes, the composition consisting of:
atactic polyproplyene;
KEP/VISTALON ethylene propylene;
a compound of ethylene-vinyl acetate copolymer, vinyl acetate, and process aid;
a compound of polyethylene wax, paraffin wax, and G.M.S;
precipitated amorphous silica;
a compound of oleo-chemical derivatives;
a compound of fatty acid ester, fatty amide, and partially saponified butyl ester;
a compound of octadecenamide, stearic amide, steyl amide, and stearic acid amide; and
anatase titanium di-oxide.

10. An outsole for shoes made of the composition as claimed in claim 9.

11. A composition of a master batch for manufacturing an outsole of shoes, the composition consisting of:
atactic polyproplyene;
KEP/VISTALON ethylene propylene;
a compound of ethylene-vinyl acetate copolymer, vinyl acetate, and process aid;
a compound of polyethylene wax, paraffin Wax, and G.M.S;
precipitated amorphous silica;
a compound of oleo-chemical derivatives;
a compound of fatty acid ester, fatty amides, and partially saponified butyl ester;
a compound of octadecenamide, stearic amide, steyl amide, sand tearic acid amide; and
titanium dioxide, aluminum hydroxide, amorphous silica.

12. An outsole for shoes made of the composition as claimed in claim 11.
